(19) United States
(12) Patent Application Publication
(10) Pub. No.: US 2019/0320624 A1
(43) Pub. Date: Oct. 24, 2019

(54) METHOD AND DEVICE FOR COMBATING SALMON LICE AND OTHER ECTOPARASITES IN FISH

(71) Applicant: Guido Becker, Goslar (DE)

(72) Inventor: Guido Becker, Goslar (DE)

(21) Appl. No.: 16/464,306

(22) PCT Filed: Nov. 24, 2017
(86) PCT No.: PCT/DE2017/000409

§ 371 Date: May 28, 2019

(30) Foreign Application Priority Data
Nov. 30, 2016 (DE) 10 2016 014 424.6
Nov. 30, 2016 (DE) 20 2016 007 407.6
Jan. 5, 2017 (DE) 10 2017 000 208.8
Jan. 5, 2017 (DE) 20 2017 000 159.4
Jan. 17, 2017 (DE) 10 2017 000 549.4
Jan. 17, 2017 (DE) 20 2017 000 372.4
Jan. 25, 2017 (DE) 10 2017 000 809.4
Jan. 25, 2017 (DE) 20 2017 000 488.7

(51) Int. Cl. A01K 61/13; A01K 63/00

(52) U.S. Cl. CPC A01K 61/13; A01K 63/006

(57) ABSTRACT

The invention relates to a method for combating salmon lice and other ectoparasites in aquaculture, in which fish are breed in breeding nets, breeding containers or breeding basins inshore or offshore and are fattened. When changing from one breeding net to another breeding net, the fish swim through a channel or a pipe (3) and are subjected to UV-light treatment (4) or to pulsed ultrasonication (5) or a UV light treatment and pulsed ultrasonication, or the fish are removed for a brief period from the breeding nets or breeding containers or breeding basins and are subjected to UV treatment or infra-red treatment (13) and/or are exposed to microwave irradiation (14) outside of the water.

The invention relates to a device and a method for combating salmon lice and other ectoparasites in fish, in particular in open environment and/or closed cycle aquaculture.

Salmon lice are crustaceans of around one-and-a-half centimetres in size which attach themselves to the skin of fish and which eat their tissue, flesh and blood. If young salmon are infested with multiple lice, they become so weakened that they may die as a result.

The main source of infection is aquaculture due to the high population density. Following accidents, infected salmon have escaped from aquaculture, such that today, even wild salmon stocks in the North Atlantic are threatened. (See Spiegel Online, 07.11.2012—“Lachsläuse” (in English: Salmon Lice).

Thermal, mechanical, biological and pharmaceutical means are used to combat salmon lice. The manufacturer Ocea Chile has developed a thermolicer, in which the salmon are pumped into a warm water bath for 30 seconds. The lice do not survive the abrupt temperature change and die (specialist journal publisher, Hamburg, Fish magazine dated 24 Apr. 2014). This treatment entails high levels of stress for the salmon.

In WO 2014/184 766 A1, artificially generated gas bubbles are used to remove parasites in aquaculture. For this purpose, the salmon, which is bred and fattened in breeding nets close to the coast or offshore, are guided via a funnel through a channel in which water turbulences resulting from the gas bubbles remove the parasites. On the outlet side of the channel, there is a capture net occupied by the treated salmon.

Other salmon breeders use lumpfish as cleaner fish, which each the salmon lice off the salmon. This requires additional systems for breeding the lumpfish, which is a considerable disadvantage.

Additionally, salmon are treated with medication during the production cycle. The relevant preparations are, for example, known from EP 0 407 343 A2, EP 0 590 425 A1 and DE 196 53 417 A1. The use of such medication is likely to lead to environmental damage that is scarcely predictable.

In the literature, as a further option, reference is made to the irradiation of the salmon with laser light bundles, although this is technically complex. Prior to treatment, the parasites have been detected optically (EP 2 962 556 A1, WO 2011/115 496 A1).

Furthermore, it is known from the prior art that the movement, size and type of swimming and non-swimming water organisms can be detected using LED irradiation in the infrared range (DE 10 2011 051 279 A1). Microwaves are known for disinfecting cultivated water (DE 101 01 625 A1).

With the recommended method and devices for combating salmon lice and other fish parasites, in particular in aquaculture, only partial successes have been achieved to date, in some cases involving high production cost increases.

The object of the invention is to recommend a method and a device for combating salmon lice, in particular in aquaculture, which are effective in terms of handling, which only expose the salmon to a low stress factor, and which are environmentally friendly.

This object is attained with method claim 1 and the device claims 11 and 21. Advantageous configurations are the subject of the subclaims.

The method according to the invention for combating salmon lice and other ectoparasites in aquaculture, in which fish are bred and fattened in breeding nets or breeding containers or tanks close to the coast or offshore, provides that on changeover from one breeding net to another breeding net, the fish swim through a channel and are subjected in the process to UV light treatment or pulsed ultrasonication or UV light treatment and pulsed ultrasonication or the fish are removed briefly from the breeding nets or breeding container or tanks and subjected to UV treatment or infrared treatment and/or microwave irradiation out of the water.

Preferably, the UV light is UVC light. Preferably, the ultrasound is low-frequency ultrasound with a frequency of between 15-35 kHz.

A further configuration of the method provides that the UV light treatment is performed at the same time as or after ultrasonication.

Further, it has been shown to be advantageous when the infrared irradiation and/or the microwave irradiation is/are performed in a pulsed manner.

Since it has been shown that when treating the fish in the water, on the one hand, irradiation, in particular UV and UVC irradiation, is absorbed and on the other, the channel cannot not be too small, either, due to the through-flow of fish, so that this absorption is no longer substantial, the invention also provides for treatment outside of the water.

In order to make this as stress-free as possible for the fish, it is further provided that the UV irradiation is performed out of the water on an anaesthetized fish.

It is further advantageous, with regard to minimising stress, when the UV irradiation, the infrared irradiation and/or the microwave irradiation out of the water can be connected with grading of the fish and/or inoculation.

In a further configuration of the method, it is provided that the ectoparasite infestation and/or the weight class of the fish are detected by sensor out of the water prior to the UV irradiation and/or microwave irradiation and evaluated using a computer, in order to generate a signal for the UV radiation dose therefrom, for the generation of the infrared irradiation dose and/or the microwave intensity.

The invention will now be explained below with reference to the drawings, in which:

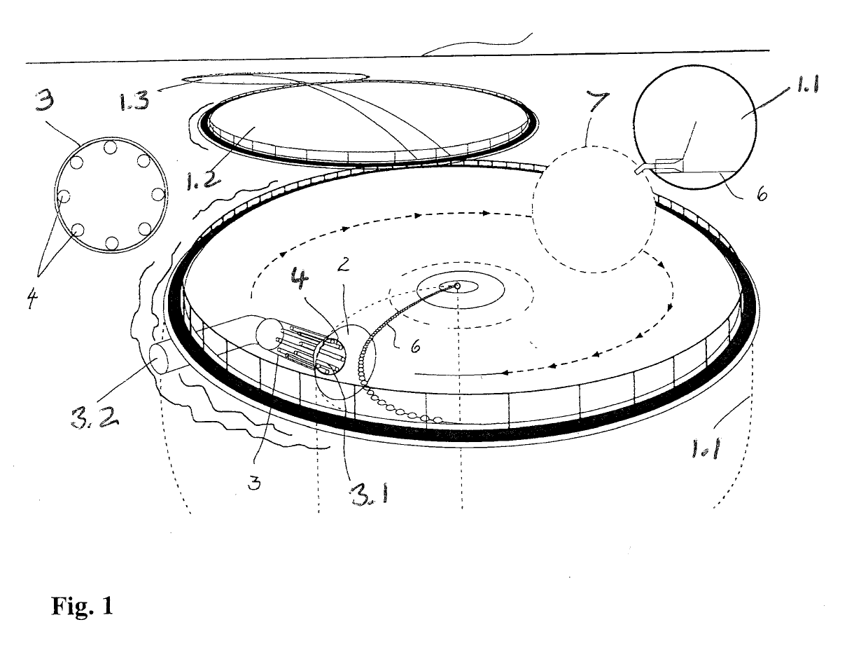

FIG. 1 shows parts of an aquaculture system,

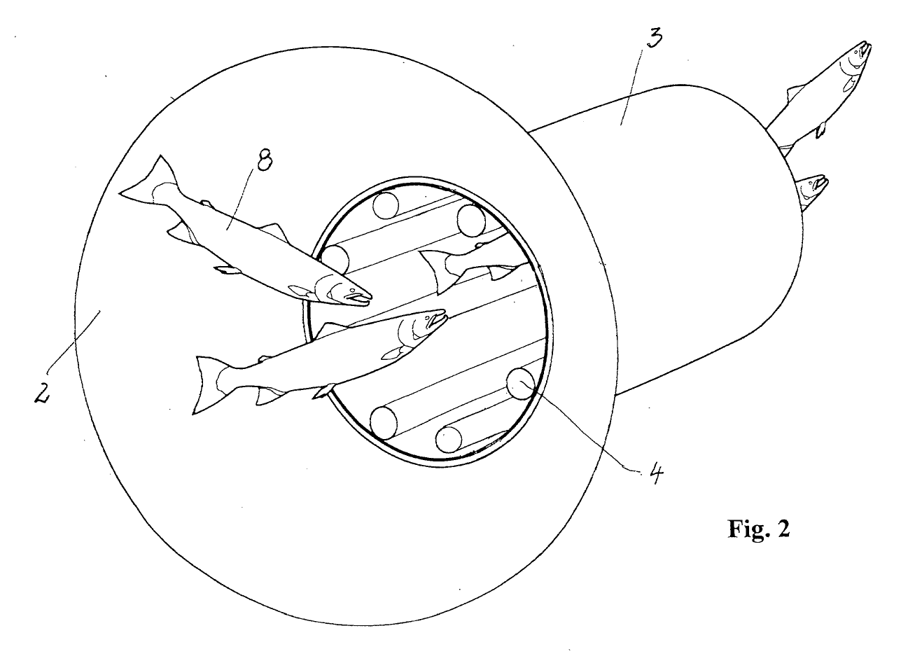

FIG. 2 shows salmon in the funnel and in the channel with UV light treatment,

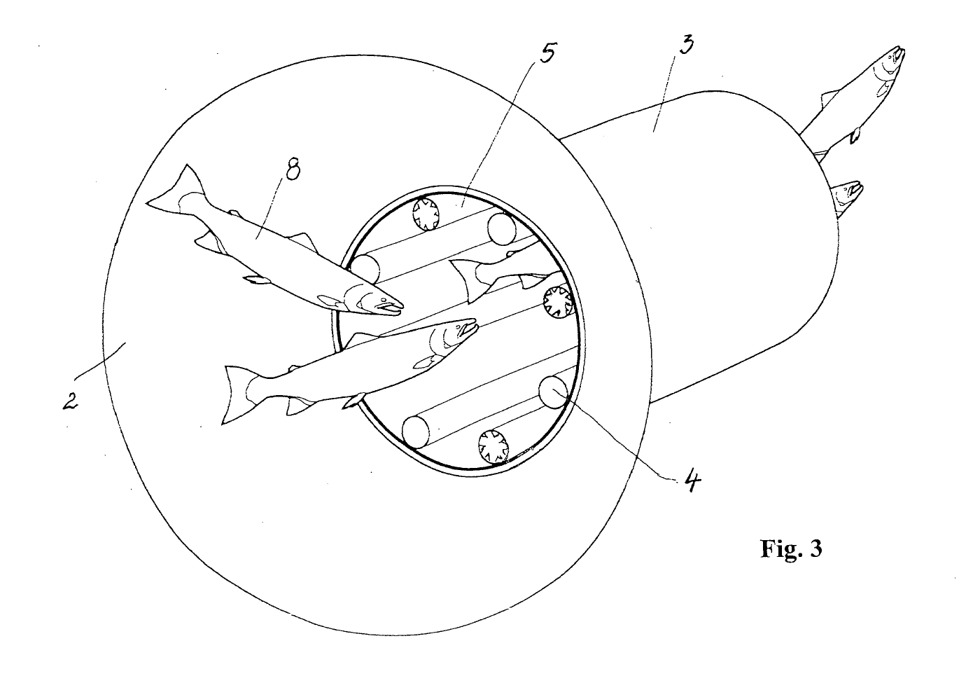

FIG. 3 shows salmon in the funnel and in the channel with UV and ultrasound treatment,

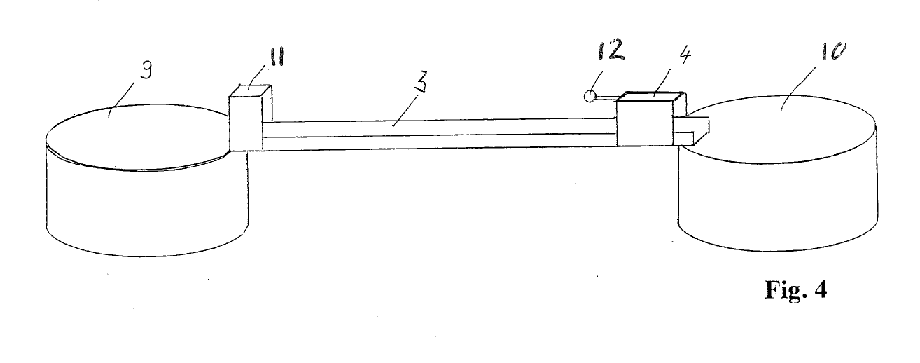

FIG. 4 shows UV treatment out of the water and

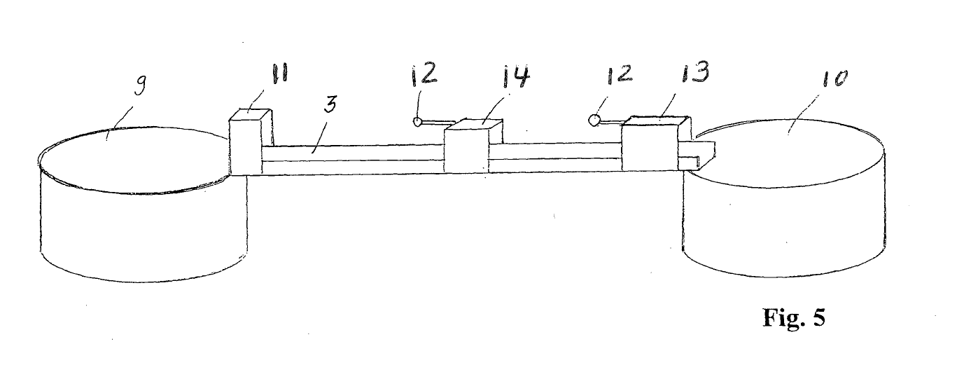

FIG. 5 shows microwave treatment and infrared treatment out of the water.

FIG. 1 shows an aquaculture complex with three breeding nets 1.1-1.3. In the front breeding net 1.1 there is a funnel 2, which opens out into a channel 3 with a channel inlet 3.1 and a channel outlet 3.2.

In this case, the channel 3 is a pipe in which UV light sources 4, in this case UVC light sources, are arranged at the circumference and running in the longitudinal direction of the pipe. The channel outlet 3.2 opens out into a capture net 7. Further, in the breeding net 1.1 there is a guide net 6, which directs the salmon 8 towards the funnel 2.

The guide net 6 is buoyantly arranged in the breeding net 1.1 and in this case comprises half of the net profile of the breeding net 1.1. Since salmon 8 are inclined to swim in a circle in the breeding net 1.1—indicated here by the arrows—this movement can be systematically used in order to direct the salmon 8 in a relatively stress-free manner with the guide net 6 into the funnel 2. The pipe that forms the channel 3 can also support the freedom from stress of swimming through the pipe by means of a corresponding diameter.

FIG. 2 shows, in an enlarged view, how the salmon 8 are guided through the funnel 2 into the channel 3 and swim through said channel, wherein they are irradiated by the UV light sources 4 with UVC light.

This is achieved on all sides by the arrangement of the UV light sources 4 over the circumference. Due to the UVC light, the salmon lice are destroyed, damaged or impaired such that they fall off the salmon 8. As a result, the salmon 8 reaching the capture net 7 are essentially lice-free. This can be monitored and if necessary, the procedure can be repeated.

One design of the aquaculture system provides that the breeding nets 1.1-1.3 are connected to each other via blockable accesses, so that salmon 8 is redirectable into the breeding net 1.1 from the other breeding nets 1.2, 1.3 and are subjected to de-licing. The de-liced salmon from the capture net 7 are first redirected into one of the breeding nets 1.2, 1.3 that have become vacant. Naturally, it is also possible to connect the channel 3 with another capture net 7.

It is also possible, taking into account the corresponding irradiation doses, to treat other fish infested with parasites.

FIG. 3 shows in an enlarged view how the salmon 8 are guided through the funnel 2 into the channel 3 and swim through said channel, wherein they are treated by the ultrasound of the ultrasonicators 5 and the UV light sources 4.

This is achieved on all sides by the arrangement of the ultrasonicators 5 and the UV light sources 4 distributed over the circumference. As a result of the ultrasound and the UV light, the lice or the other ectoparasites are destroyed, damaged, or impaired such that they fall off the salmon 8. Consequently, the salmon 8 that reach the breeding net 1.2 are essentially louse- or parasite-free. This can be conducted in a controlled manner and if necessary, the procedure can be repeated. One configuration of the aquaculture complex provides that the breeding nets 1.1-1.3 are connected to each other via blockable accesses, so that salmon 8 is redirectable into the breeding net 1.1 from other breeding nets, and are then subjected to treatment. The treated salmon 8 from the breeding net 1.2 are previously redirected into one of the breeding nets that have become vacant.

Naturally, it is also possible to connect the channel 3 with another breeding net 1. The fish guidance device from the funnel 2 and the guide net 6 and the channel 3 can also be designed as mobile units, so that they can be redeployed from one breeding net into another breeding net.

The device and the method have been explained using aquaculture as an example. However, it is also possible to install UV light sources 4 with UVC light or ultrasonic generators in fish sluices, as a result of which wild salmon is also treatable, at least on a certain scale.

FIG. 4 shows in a simplified representation a breeding and fattening complex for salmon 8 with an anaesthesia tank 9 for the salmon 8. From this anaesthesia tank 9, the salmon 8 are transferred to a transport duct 3 by means of a removal device 11, where the usual vaccinations are conducted. The salmon 8 pass through this transport duct 3 and then reach a rest tank 10 in order to “wake up”.

Along the way through the transport duct 3, the salmon 8 pass a UV irradiation device 4, which is shielded towards the outside. The UV irradiation device 4 can be arranged on any section of the transport duct 3.

Due to the fact that the salmon 8 are located outside the water, the precise dosage of the UV irradiation in order to destroy the salmon lice is now possible.

Since the salmon 8 are already anaesthetised for vaccination purposes and have been removed from the water, they are not exposed to additional stress by the UV irradiation.

In addition to the vaccination, UV irradiation can be conducted during sorting. This can be conducted with or without anaesthesia. The deciding factor is that the fish are also removed from the water in this case.

FIG. 5 shows in a simplified representation a breeding and fattening complex for salmon 8 with a tank 9 for the salmon 8. From this tank 9, the salmon are transferred to a transport duct 3 by means of a removal device 11. The salmon 8 pass through this transport duct 3 and then reach a second tank 10.

Along the way through the transport duct 3, the salmon 8 pass a microwave generator 14 and an infrared irradiation device 13, which are both shielded towards the outside. The microwave generator 14 and the infrared irradiation device 13 can also be arranged in inverse sequence on the transport duct 3.

Due to the fact that the salmon 8 are located out of the water, a precise dosage of the infrared irradiation and the microwave intensity for destroying the salmon lice is now possible.

Preferably, sensors 12 are connected upstream of the infrared irradiation device 13 and the microwave generator 14, these sensors detecting the ectoparasite infestation and/or the weight class of the salmon 8. The sensor signals are processed by computer and are used to control the infrared radiation dose and/or the microwave intensity.

Since the salmon 8 are anaesthetised e.g. for vaccination purposes, and are removed from the water, they are not subjected to additional stress resulting from the infrared irradiation or microwave irradiation.

### LIST OF REFERENCE NUMERALS

1.1-1.3 Breeding net
2 Funnel
3 Channel, pipe, transport duct
3.1 Channel inlet
3.2 Channel outlet
4 UV irradiation device, UV light source
5 Ultrasonicator
6 Guide net
7 Capture net
8 Fish, in this case salmon
9 Tank
10 Tank
11 Removal device
12 Sensors
13 Infrared irradiation device
14 Microwave generator

1. A method for combating salmon lice and other ectoparasites in aquaculture, comprising
breeding and fattening fish in breeding nets or breeding containers or tanks close to the coast or offshore, and
while changing from one breeding net to another breeding net, swimming the fish swim through a channel or a pipe and subjecting them in the process to at least one of UV light treatment and pulsed ultrasonication or
removing the fish briefly from the breeding nets or breeding container or tanks and subjecting them to at least one of UV treatment, infrared treatment and microwave irradiation out of the water.

2. The method according to claim 1, wherein the UV light is UVC light.

3. The method according to claim 1, wherein the ultrasound is low-frequency ultrasound with a frequency of between 15-35 kHz.

4. The method according to claim 1, wherein the UV light treatment is performed before, at the same time as or after ultrasonication.

5. The method according to claim 1, wherein the infrared irradiation and/or the microwave irradiation is/are performed in pulsed manner.

6. The method according to claim 1, wherein the UV irradiation is performed out of the water on an anaesthetized fish.

7. The method according to claim 1, wherein the UV irradiation out of the water is performed with at least one of grading of the fish and inoculation.

8. The method according to claim 1, wherein at least one of the ectoparasite infestation and the weight class of the fish is detected by sensor out of the water prior to the UV irradiation and evaluated using a computer, and generating therefrom a signal for the UV radiation dose.

9. The method according to claim 1, wherein at least one of the infrared irradiation and the microwave irradiation is connected with at least one of grading of the fish and inoculation.

10. The method according to claim 1, wherein at least one of the ectoparasite infestation and the weight class of the fish is detected by sensor prior to the infrared irradiation or the microwave irradiation and evaluated by computer in order to generate a signal for the infrared radiation dose or the microwave intensity therefrom.

11. A device for carrying out the method according to claim 1 for combating salmon lice and other ectoparasites in aquaculture, comprising
at least one of breeding nets (1.1-1.3) or other breeding containers or tanks (9, 10) close to the coast or offshore in which fish (8) are bred and fattened,
a channel (3) or a pipe through which the fish (8) swim on changeover from one breeding net (1.1) to another breeding net (1.2), wherein the channel (3) or the pipe (3) has at least one UV light source (4) or ultrasonicator (5), which shines into the channel (3) or pipe and subjects the fish in the changeover process to at least one of UV light treatment and pulsed ultrasonication.

12. The device according to claim 11, wherein a guide net (6), which directs the fish (8) towards at least one funnel (2), is arranged in the at least one breeding net (1.1).

13. The device according to claim 11, wherein the channel (3) is a pipe with a closed or net-like shell.

14. The device according to claim 11, wherein the at least one UV light source (4) is arranged at the pipe circumference and in the longitudinal direction of the pipe and shines into the pipe cross-section.

15. The device according to claim 11, wherein the at least one UV light (4) source is multiple UV light sources (4), and wherein the distribution of the multiple UV light sources (4) is in the longitudinal direction of the pipe in such a way that the fish (8) swimming through the pipe (3) undergo a sufficient amount of irradiation with UV light which is effective against the salmon louse.

16. The device according to claim 11, wherein the at least one UV light source (4) emits a UVC light with a wavelength of below 300 nm.

17. The device according to claim 11, wherein the at least one breeding net (1.1) is connected to other breeding nets via access points that are able to be shut off.

18. The device according to claim 11, wherein the channel (3) or the pipe is connectable or connected with further receiving nets or breeding nets emptied of un-irradiated fish (8).

19. (canceled)

20. The device according to claim 11, wherein the one or more ultrasonicators (5) is arranged in front of, next to and/or behind the UV light source (4).

21. A device for carrying out the method according to claim 1 for combating salmon lice and other ectoparasites in aquaculture, comprising
at least one of breeding nets or breeding containers or tanks (1, 9, 10) close to the coast or offshore in which fish (8) are bred and fattened, and
at least one source of infrared treatment or microwave irradiation to which the fish (8) are subjected on changeover from one breeding net or container or tank to another breeding net or container or tank while being removed briefly from the breeding net or container or tank and while out of the water, or
a transport duct (3), wherein the transport duct (3) is equipped with at least one of an infrared irradiation device (13), a microwave generator (14) and a UV light source (4) which shine into the transport duct (3) to treat the fish against ectoparasites during changeover of fish from one breeding net or container or tank to another breeding net or container or tank.

22. (canceled)

23. (canceled)
